(19) United States
(12) Patent Application Publication
(10) Pub. No.: US 2005/0211448 A1
(43) Pub. Date: Sep. 29, 2005

(54) Grease fire extinguisher

(76) Inventors: Anton Neumeir, Mering (DE); Reinhard Effenberger, Anwalting (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 11/046,638

(22) Filed: Jan. 28, 2005

(30) Foreign Application Priority Data
Mar. 26, 2004 (DE) 10 2004 014 780.9

(51) Int. Cl. A62C 2/00

(52) U.S. Cl. 169/65; 239/463

(57) ABSTRACT

In a grease fire extinguisher which is operated with a pressurized fire extinguishing liquid, a nozzle body having a plurality of atomizing nozzles is provided, wherein each atomizing nozzle includes a twist member arranged in a nozzle plate ahead of the nozzle discharge opening for applying a spin to the extinguishing agent before it reaches the nozzle opening.

### BACKGROUND OF THE INVENTION

The present invention relates to a grease fire extinguisher with a small fill volume of a liquid grease fire extinguishing agent which is pressurized and, for extinguishing a fire, is discharged through a plurality of small atomizing nozzles.

The extinguishing of grease fires has always been a major problem. After extensive tests, among others, of professional associations in the food industry and restaurants it has been determined that the extinguishing agents used so far such as powder, carbon dioxide etc., are not suitable, or only insufficiently suitable, for extinguishing grease fires. For that reason, special extinguishing agents for extinguishing grease fires have been developed.

Such a grease fire extinguishing agent is known and used under the product designation “FettEx”.

In order to achieve the standards as determined by the European guidelines (EN3), that is to successfully extinguish certain standardized test objects, pressurized liquid fire extinguishing apparatus of the type used in connection with water or foam extinguishers having a fill volume of at least 6 liter filled with this grease fire extinguishing agent are used in order to provide a sufficient amount of extinguishing agent for extinguishing grease fires.

It is the object of the present invention to provide a grease fire extinguishing apparatus which requires a smaller amount of grease fire extinguishing agent for achieving the same fire extinguishing results.

### SUMMARY OF THE INVENTION

In a grease fire extinguisher which is operated with a pressurized fire extinguishing liquid, a nozzle body having a plurality of atomizing nozzles is provided, wherein each atomizing nozzle includes a twist member arranged in a nozzle plate ahead of the nozzle discharge opening for applying a spin to the extinguishing agent before it reaches the nozzle opening.

The grease fire extinguishing apparatus according to the invention accordingly uses an especially configured nozzle—in contrast to the grease fire extinguishing apparatus presently in use which, although using liquid grease fire extinguishing agents, are otherwise of conventional design—including extinguishing gun and extinguishing agent hose. The effects achieved unexpectedly with the apparatus according to the invention are impressive in that, instead of the need for six liters of the liquid grease fire extinguishing agent “FettEx” needed so far to obtain a safe extinguishing result, a two liter fill volume for the fire extinguishing apparatus has been found to be sufficient.

The extinguishing agent “FettEx” (approval number PL. 13/2000) is a special liquid extinguishing agent for oils and food grease which forms a closed gas tight foam cover and instantly smothers the fire. It also has a very good cooling effect whereby heat is removed from the oil or grease and the ambient. It is however very important that, for achieving this result, the extinguishing agent is applied in a very finely atomized manner.

The commercially available grease fire extinguishing agent “FettEx” has the following technical specification”:

| | |
|---|---|
| Density | 1.28 kg/l |
| pH value | About 8.5 |
| Refraction index nD₂₀ | 1.40 |
| Viscosity at +20° C. | 5 ± 0.5 mm²/s |
| Viscosity at −15° C. | 29 ± 3.0 mm²/s |

Care must be taken that, in order to achieve optimal fire extinguishing results, an extinguishing impulse in accordance with the following formula is maintained:
Extinguishing impulse I=V/t×A,
wherein V is the extinguishing volume, t is the extinguishing duration and A is the fire area. The flow volume for the grease fire extinguisher according to the invention with a 2 liter fill volume may be 6 up to maximally 12 liter per minute.

The grease fire extinguisher according to the invention has substantial advantages particularly because it requires only a relatively small amount of extinguishing agent. Based for example on a situation involving a burning deep-frying pan with a capacity of 36 kg ?deep frying grease or oil as it is used in restaurants and as provided as standardized test object for fire extinguishing tests for the extinguishing of such a burning deep frying pan with a conventional fire extinguisher of at least 6 liter fill volume the deep frying pan may overflow together with hot grease or oil. This is dangerous since, with the overflowing grease or oil, other objects can be ignited even if the fire is extinguished since the overflowing grease or oil still has a temperature of about 300° C. It is also dangerous if the overflowing oil or grease comes into contact with water which results in sudden vaporization of the water with the possibility that persons present may get burnt.

The effectiveness of the grease fire extinguisher according to the invention resides in the fact that the liquid fire extinguishing agent is applied in an optimal form and the optimally applied fire extinguishing agent is so effective with an application of only a relatively small amount of fire extinguishing agent.

The invention will be described below in greater detail with reference to the accompanying drawings.

### BRIEF DESCRIPTION OF THE DRAWINGS

FIG. 1 shows a grease fire extinguisher provided with a special extinguishing foam nozzle according to the invention,

FIG. 2 is a perspective exploded view of the foam nozzle of the grease fire extinguisher according to the invention,

FIG. 3 is a front view of the foam nozzle shown in FIG. 1, and

FIG. 4 shows the foam nozzle in an axial cross-sectional view.

### DESCRIPTION OF A PREFERRED EMBODIMENTS

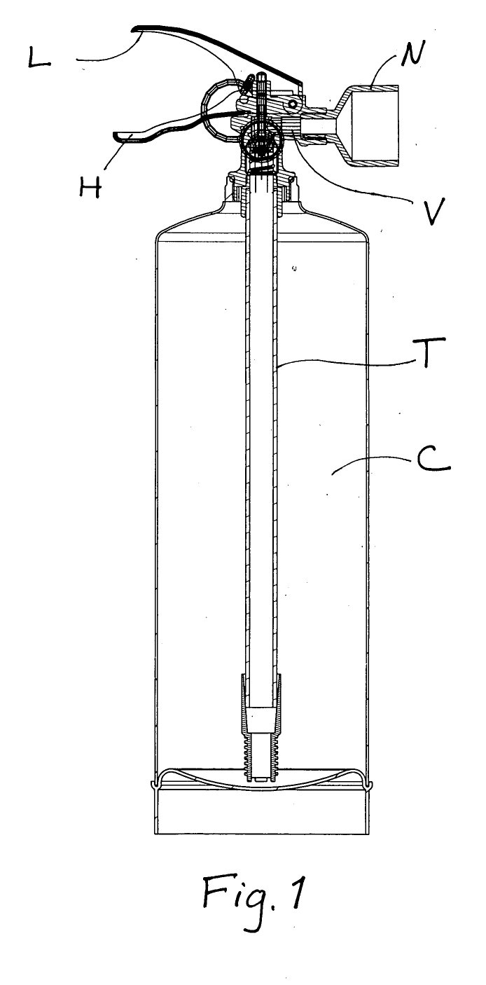

FIG. 1 shows the grease fire extinguisher according to the invention, which includes a container C of 2 liter fill volume for a fire extinguishing agent, with a riser tube T, a handle H, a valve V, a valve operating lever L and a particularly configured nozzle 1.

The apparatus operates with an operating pressure of 12 to 18 bar.

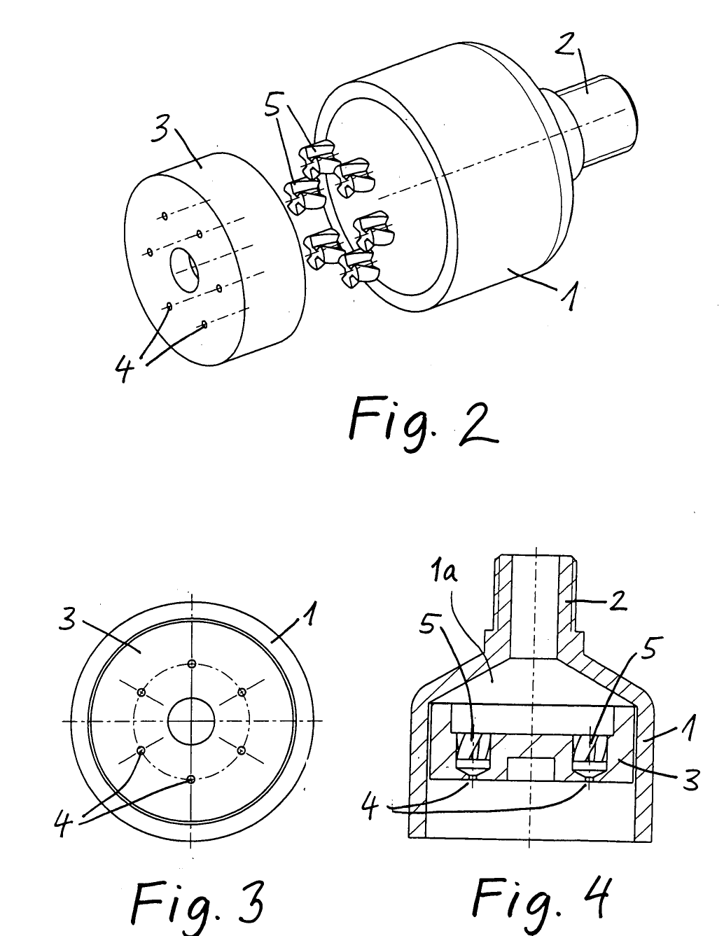

The FIGS. 2 to 4 show only the nozzle since, otherwise, the apparatus is of conventional design. The nozzle, which is shown in FIGS. 2 to 4, is screwed directly into the discharge valve V of the apparatus.

As shown in the figures, the nozzle comprises a cup body 1 with a neck 2 provided with an external thread for threading the body into the discharge valve. Into the cup body 1, an atomizing plate 3 is inserted which includes for example six nozzle openings 4 arranged in a circle in uniformly spaced relationship. The space behind the atomizer plate 3 in the cup body 1 is in the form of a diverging diffuser chamber 1a. The nozzle openings 4 are each relatively small and become larger toward the neck 2 so as to form a cone with a large cone angle followed by a cylindrical passage, which has a substantially layer diameter than the opening 4. In each cylindrical passage, a twist member 5 is disposed. The twist member 5 is clearly shown in the exploded view of FIG. 2. Their arrangement in the atomizer plate 3 is shown in the cross-sectional view of FIGS. 2 and 4. The twist member 5 includes spiral grooves and, in cooperation with the nozzle openings 4, provides for the atomization of the liquid extinguishing agent supplied from the extinguishing agent container through the threaded neck 2 in a uniformly diverging spray jet of about 40 cm diameter. With the operating pressure of the apparatus of 12 to 18 bar, a jet length of 2-3 m is obtained.

The grease fire extinguisher is preferably in the form of a continuous pressure fire extinguisher. Since in continuous pressure fire extinguishers the pressure slowly drops during the fire extinguishing procedure the travel distance of the spray range is correspondingly becoming smaller. For the application considered herein, that is for extinguishing grease fires, this is not an important factor.

Because of the configuration of the nozzle of the grease fire extinguisher shown in FIGS. 2-4, a finely atomized uniform spray jet of a diameter of about 40 cm is generated which rapidly forms a dense extinguishing agent layer over the fire source and, with a relatively small amount of fire extinguishing agent, chokes the fire and rapidly cools the fire source.

1. A grease fire extinguisher for use in connection with a liquid grease fire extinguishing agent, said fire extinguisher being in the form of a pressurized fire extinguisher comprising a nozzle body (1) having a plurality of atomizing nozzles (4) with openings, and a twist member (5) arranged in each atomizing nozzle ahead of the nozzle opening for applying a spin to the fire extinguishing agent before it reaches the nozzle opening.

2. A grease fire extinguisher according to claim 1, wherein the atomizing nozzles (4) are arranged in a parallel flow relationship on an atomizing plate (3) having passages with small nozzle openings and a twist member (5) disposed in each of the passages ahead of the respective nozzle opening of the atomizing plate (3).

3. A grease fire extinguisher according to claim 2, wherein the atomizing nozzles are arranged in the atomizing plate (3) in a circular array.

4. A grease fire extinguisher according to claim 2, wherein the nozzle body (1) is a cup-like body forming a divergent diffuser chamber between an inlet neck (2) and the atomizing plate (3) disposed in an inlet area thereof.

5. A grease fire extinguisher according to claim 4, wherein the inlet neck (2) is threaded directly onto a discharge valve of a fire extinguishing agent container.

6. A grease fire extinguisher according to claim 1, wherein the fire extinguisher is operated at a pressure of 12-18 bar.
